(19) United States
(12) Patent Application Publication
(10) Pub. No.: US 2003/0124940 A1
(43) Pub. Date: Jul. 3, 2003

(54) Tunable or adjustable liner for selectively absorbing sound energy and related methods

(76) Inventor: Rajendran S. Michael, Granville, OH (US)

Correspondence Address: OWENS CORNING, 2790 COLUMBUS ROAD, GRANVILLE, OH, 43023, US

(21) Appl. No.: 10/039,026

(22) Filed: Dec. 31, 2001

(51) Int. Cl. B32B 5/26; D04H 3/00; D04H 1/00

(52) U.S. Cl. 442/391; 442/415; 442/334

(57) ABSTRACT

A liner is disclosed that is capable of being tuned or adjusted during manufacturing to absorb or reflect sound energy, as necessary or desired for a particular application. The liner is formed of a composite material comprising a combination or mixture of mineral fibers, such as glass fibers, and organic fibers, such as polypropylene fibers.

### CROSS REFERENCE TO RELATED APPLICATION

This application is related to patent application, U.S. Serial No. ______—(Attorney Docket No. 25143) filed concurrently herewith, by Rajendran S. Michael et al., and entitled “VEHICLE ENERGY ABSORBING ELEMENT,” the disclosure of which is incorporated herein by reference.

### TECHNICAL FIELD AND INDUSTRIAL APPLICABILITY OF THE INVENTION

The present invention relates to a liner formed of a composite material that may be selectively adjusted or tuned to absorb or reflect sound energy in certain areas or regions.

### BACKGROUND OF THE INVENTION

Various types of materials have been proposed for use as insulating liners to absorb sound energy and thus enhance the acoustical environment in which the liners are used. One area where acoustically insulating liners find significant utility is in vehicles, such as cars, trucks, vans, or the like, where they may be used as a hoodliner for insulating the space above the engine compartment, a headliner for insulating the ceiling in the interior passenger compartment, or as a filler for insulating the cavities in the doors or like spaces. Other less prevalent, but possible uses of acoustically insulating liners are in the visor(s), under the carpet or other floor covering, in the dashboard, the console, or in other areas where it is desirable to insulate against ambient sound energy.

In early proposals, liners were often formed of cellular foam, such as polyurethane, having a substantially constant thickness and a fixed cell size. Generally, the thicker the foam, the greater the amount of sound energy absorbed. However, even moderately thick cellular foam is relatively expensive, even when formed out of polymeric materials, such as polyurethane. Also, thick substrates of foam cannot always be used in locations where space is limited, such as in the headliners of certain vehicles having a low profile passenger compartment, in visors, or in dashboards.

As a result of these limitations, the focus in the past has generally been on fabricating a liner formed of a reduced, but constant thickness of cellular foam to absorb sound energy in the passenger compartment. To enhance the sound absorption properties, additional layers of material are often attached to this thinner layer of foam.

In an effort to provide an acoustically enhanced liner, a number of proposals for a selectively tunable headliner have been made. One approach suggests providing cavities or channels in one or more layers of a relatively thin layer of a foam material. These cavities or channels are designed to create Helmholtz resonators. Examples are found in both U.S. Pat. No. 5,892,187 to Patrick and U.S. Pat. No. 6,033,756 to Handscomb.

Creating a liner having a plurality of strategically placed cavities or channels, each capable of acting as a Helmholtz resonator, may be an expensive and labor-intensive undertaking. The cavities or channels serving as the resonators must be carefully designed and positioned to ensure that the absorption and reflectance of sound energy is as desired. Despite the design and manufacturing expense, if the resonators are not properly formed or are damaged during use or installation, the desired acoustical enhancement will not be realized.

In addition to absorbing sound energy, headliners must also be capable of absorbing energy to meet the governmentally established head impact criteria (HIC) for passenger vehicle compartments. However, a unitary headliner formed of a homogeneous foam material having a variable contour to create the thickness necessary to meet the head impact criteria is difficult to manufacture. This is primarily due to the inability of current processes to efficiently and effectively produce the sharp contours in the foam necessary to create perimeter regions having an increased thickness, while keeping the other portions of the foam relatively thin to lower the cost. As a result, past proposals for meeting the head impact criteria generally involve attaching one or more separate components, such as pads or the like, to the perimeter of the headliner. Of course, this extra step may in some cases increase the manufacturing effort and concomitant expense. Also, the component or pad for absorbing head impact energy is usually formed of a different material from the headliner, thus requiring an extra step to separate the two materials prior to recycling.

### SUMMARY OF THE INVENTION

Accordingly, a liner is disclosed that is not only simple and inexpensive to manufacture, but also capable of being easily tuned or adjusted during manufacturing to absorb or reflect sound energy, as necessary or desired for a particular application. The reduced expense and ease of manufacture is provided by forming the liner of an inexpensive, but durable composite material comprising the combination of mineral fibers, such as glass fibers, and organic fibers, such as polypropylene fibers. This composite material is easily formed into a sheet or substrate and can be selectively compressed to create variations in both the contour and thickness of the liner. By creating regions or areas of the liner that are selectively lofted or compressed, the attenuation of undesirable sound energy can be controlled as desired for a particular application. Alternatively or in addition to selectively compressing different areas or regions, the size and ratios of the mineral and/or organic fibers used to fabricate the sheet or substrate of material from which the liner is formed may be adjusted in different areas or regions to selectively absorb or reflect acoustic energy.

In one embodiment where the liner is used as a headliner in the passenger compartment of a vehicle, the manufacturing flexibility afforded by the use of this composite material would also possibly allow for the formation of an integral perimeter portion meeting the criteria for absorbing head impact energy during a collision (known as head impact criteria, or HIC). The headliner with the integral impact absorbing material may be less expensive to manufacture, and as a whole could be easily recycled without additional steps to first remove any non-homogeneous HIC material. Overall, a significant improvement is realized over prior art proposals for liners, including headliners, especially in terms of the ease with which the acoustical enhancement is achieved, the concomitant manufacturing cost, and especially in the case of a headliner having an integral HIC member, the recyclability of the resulting composite material.

In accordance with a first aspect of the present invention, an acoustically enhanced liner for selectively insulating a portion of a vehicle from ambient sound energy is provided. The liner comprises a base portion fabricated of a composite material comprised of a plurality of mineral fibers and a plurality of organic fibers. The base portion has at least one lofted region for substantially absorbing a portion of the ambient sound energy and at least one compressed or compacted region.

The mineral fibers may comprise glass fibers and the organic fibers may be polypropylene, polyphenylene sulfide, and polyethylene terephthalate or any other suitable material.

The base portion may further include an integral lofted perimeter region that is capable of absorbing a portion of impact energy created during a collision. Alternatively, a separate component may be coupled to at least a portion of a perimeter region of the base portion. The separate component is capable of absorbing a portion of impact energy created during a collision. The separate component may be attached to the base portion using an adhesive. The separate component may be fabricated of a composite material comprised of a mixture of mineral fibers and organic fibers.

The base portion may be contoured for use as a headliner in a passenger compartment in a vehicle and wherein the at least one lofted region is positioned overlying a driver's seat when installed in the vehicle.

The liner may further include a fabric layer secured to the base portion. It is also contemplated that a foam layer may be positioned between the base portion and the fabric layer.

The base portion may include an angled region, section or area, whereby ambient sound energy is reflected from the angled region, section or area in a particular direction.

The composite material preferably comprises a co-fiberized composite material.

In accordance with a second aspect of the present invention, an acoustically enhanced liner is provided for selectively insulating a portion of a vehicle from ambient sound energy. The liner comprises a base portion fabricated of a composite material comprised of a plurality of mineral fibers and a plurality of organic fibers. The base portion has at least one first region comprising mineral and organic fibers, where at least a portion of the mineral and organic fibers have a first diameter for absorbing a portion of ambient sound energy. The base portion also has at least one second region comprising mineral and organic fibers, where at least a portion of the mineral and organic fibers in the second region have a second diameter which is greater than the first diameter.

The base portion may further include a third region having mineral and organic fibers, at least a portion of the fibers in the third region being of a third diameter. The base portion may also include other regions having fibers of similar or other diameters as well.

In accordance with a third aspect of the present invention, a method of manufacturing a liner comprised of a base portion of a composite material including mineral fibers and organic fibers for use in a vehicle is provided. The method comprises the steps of: providing mineral and organic fibers in a first selected region of the base portion, wherein at least a portion of the fibers in the first region have a first diameter; and providing mineral and organic fibers in a second region of the base portion, wherein at least a portion of the fibers in the second region have a second diameter which is different from the first diameter. The locations of the fibers having the first and second diameters are selected to provide a desired degree of acoustical enhancement to the base portion.

The first diameter of the mineral and organic fibers in the first region is selected to result in the first region absorbing a significant portion of ambient sound energy.

The second diameter may be greater than the first diameter.

The first and second regions may be provided in a single layer. Alternatively, the first region may be provided in a first layer and the second region may be provided in a separate, second layer.

The substrate may be contoured during manufacturing for use as a headliner in the passenger compartment of an automobile. The method may further include the step of attaching a separate component to a perimeter of the base portion to absorb a portion of impact energy during a collision.

In accordance with a fourth aspect of the present invention, a method of manufacturing a liner for use in a vehicle is provided. The method comprises the steps of: providing a composite material substrate including a mixture of mineral fibers and organic fibers; and forming the composite material substrate into a base portion having one or more compacted first regions and one or more lofted second regions. The lofted regions absorb a greater amount of sound energy than the compacted regions.

The forming step may include the step of placing the substrate between a pair of opposing dies that together form a contour corresponding to the desired shape of the liner.

The forming step may include the step of compressing the first region to a first thickness and the second region to a second thickness, wherein the first thickness is less than the second thickness and the first region serves to structurally enhance the liner.

The forming step may include the step of forming the regions such that a lofted region is created in a portion of the liner that will overly the driver's seat in the vehicle.

The forming step may include the step of forming at least one of the regions such that a taper or angled region is created in a section of the base portion.

The method may further include the step of attaching a separate component to the perimeter of the base portion to absorb a portion of impact energy during a collision.

In accordance with a fifth aspect of the present invention, a headliner is provided comprising a base portion fabricated of a composite material comprised of a plurality of mineral fibers and a plurality of organic fibers. The base portion includes a lofted perimeter region that is capable of absorbing a portion of impact energy created during a collision.

The lofted perimeter region may be defined by a separate component coupled to an edge of a main body of the base portion. The separate component may be attached to the base portion main body using an adhesive or any other conventional means, such as VELCRO™. Alternatively, the lofted perimeter region is integral with an edge of a main body of the base portion.

### BRIEF DESCRIPTION OF THE DRAWING FIGURES

FIG. 1 is a partially schematic, partially cross-sectional view in elevation of an apparatus for co-fiberizing glass fibers and fibers of a polymeric material to create a composite batt for use in forming one embodiment of the headliner of this invention;

FIGS. 2a and 2b are partially schematic, partially cross-sectional views of the cold molding process used to form a liner base portion having a variable contour and thickness;

FIG. 3a is a cross-sectional view of the liner base portion taken along line 3a-3a of FIG. 3b;

FIG. 3b is a top plan view of the liner base portion constructed in accordance with one embodiment of the present invention;

FIG. 3c is an exploded cross-sectional view of a liner including optional layers of foam and fabric;

FIG. 4 is a cross-sectional view of the liner base portion including an integral lofted perimeter region for absorbing a portion of impact energy during a collision;

FIG. 5 is a cross-sectional view of the liner base portion where separate components are attached for creating a lofted perimeter region on the liner base portion for absorbing a portion of impact energy during a collision;

FIGS. 5A-5E illustrate in cross section various additional embodiments of separate impact absorbing components; and

FIG. 6 is a side view an apparatus for co-fiberizing glass fibers and fibers of a polymeric material to create a composite batt for use in forming a liner base portion in accordance with a second embodiment of this invention;

FIG. 6A is a plan view of a base portion constructed in accordance with a second embodiment of the present invention;

FIG. 6B is a cross sectional view taken along view line 6B-6B in FIG. 6A;

FIG. 7A is a plan view of a base portion constructed in accordance with a further embodiment of the present invention; and

FIG. 7B is a cross sectional view taken along view line 7B-7B in FIG. 7A.

### DETAILED DESCRIPTION AND PREFERRED EMBODIMENTS OF THE INVENTION

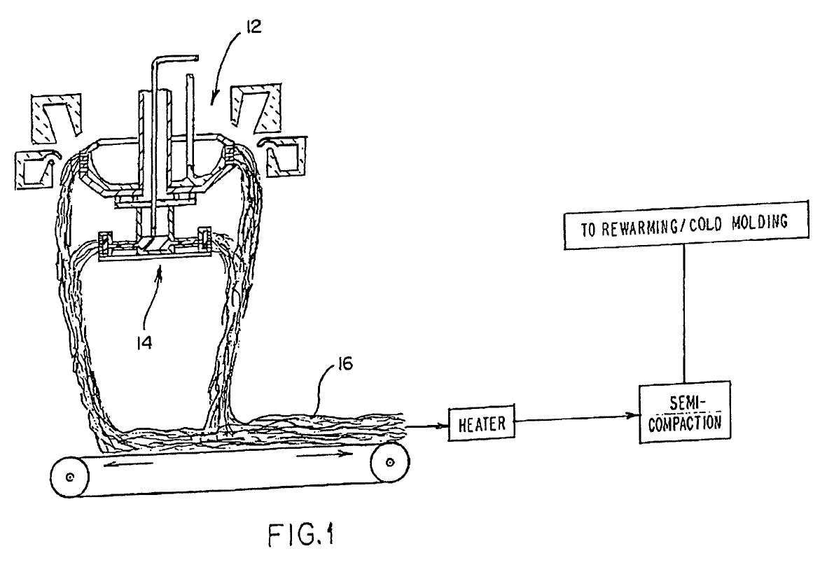

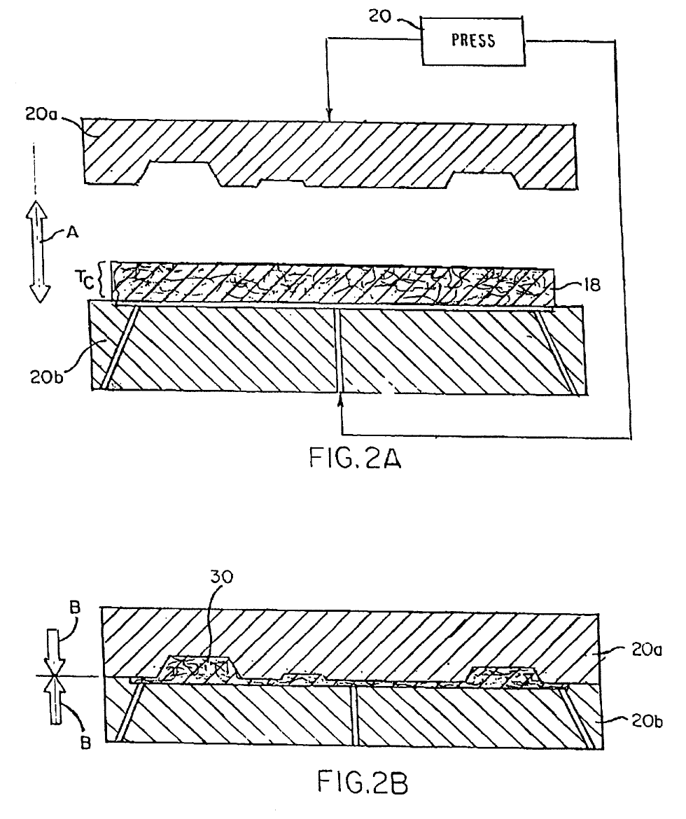

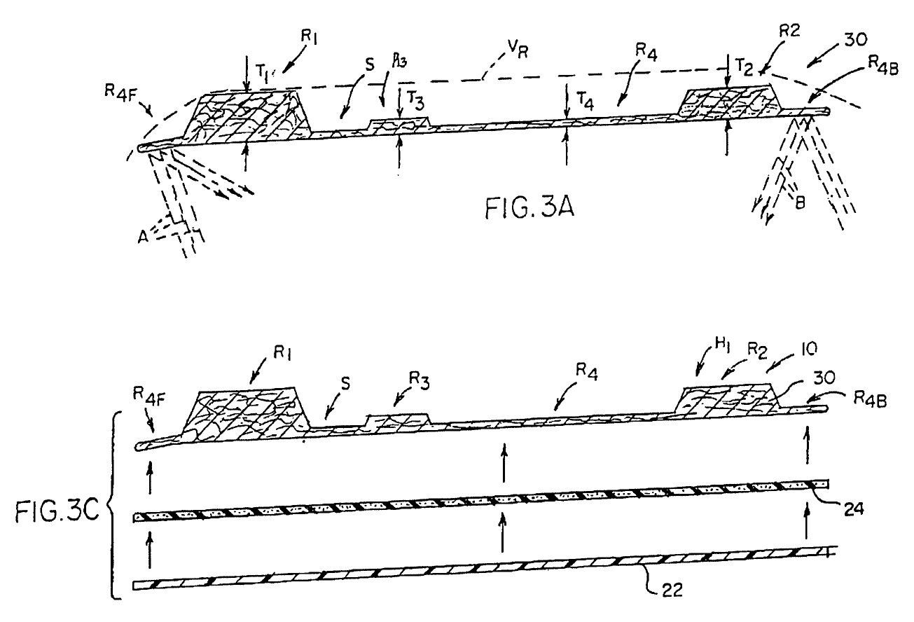

Reference is now made to FIG. 1, which illustrates a portion of a process employed to form material used in a selectively tunable liner 10, as well as FIGS. 2A-2B and 3A-3C, which show one manner of selectively tuning a base portion 30 of the liner 10 and the base portion 30 once tuned. The liner 10 may comprise only the base portion 30 or, as described below with reference to FIG. 3C, may comprise the base portion 30 and one or more additional layers.

As shown in FIG. 1, the material used to form the base portion 30 of the liner 10 is a composite comprised of both mineral fibers, such as glass fibers (such as AF, A, or recycled glass with a small amount (less than 1-3% by weight) of a sizing, primarily, so as to keep the fibers from abrading and damaging one another during processing), and organic fibers, such as polymeric fibers. The polymeric fibers may be formed from any one of the following polymeric materials: polypropylene; polybutylenes, polyhexane, polyoctane, polyester, polybutylene terephthalate (PBT); polypropylene terephthalate (PPT); polyphenylene sulfide; polyethylene terephthalate (PET); polyethylene; poly(aolefin) polymers; nylon 6; nylon 66; nylon 46; nylon 12; copolyamides; polycarbonate, copolymers of polycarbonate; polybutylene terephthalate (PBT); polypropylene terephthalate (PPT); polyphenylene ether (PPE); water soluble polymers; blends thereof and any other organic material capable of being fiberized. The mineral and organic fibers may be formed by a number of processes, as noted below, one of which involves the use of separate centrifugal spinners 12, 14 that create the fibers and allow them to mix or entangle to create a co-fiberized material. A detailed description of the overall process for this manner of forming a co-fiberized material is found in commonly assigned U.S. Pat. Nos. 5,523,031 and 5,523,032, both to Ault et al., the disclosures of which are wholly incorporated herein by reference. Descriptions of similar co-fiberizing processes and the co-fiberized materials formed thereby that may be useful in forming a tunable base portion 30 of a liner 10 according to the teachings of the present specification may also be found in commonly assigned U.S. Pat. Nos. 6,113,818; 5,900,206; 5,876,529; 5,490,961; 5,468,546; and 5,458,822, the disclosures of all of which are incorporated herein by reference.

As a result of this co-fiberizing process, and as illustrated in FIG. 1, a lofted batt 16 of a composite fibrous (mineral/organic fiber) material is formed. This lofted batt 16 may have a thickness of from about 12 inches to about 36 inches and preferably about 12 inches (about 305 mm), but this range may vary depending on the co-fiberizing process parameters (the diameter of the apertures in the spinners, the temperature and viscosity of the starting materials, the rotational velocities of the spinners, etc.). The batt 16 may comprise mineral fibers in an amount from about 5% to about 95% by weight, based on the total weight of the batt 16, and organic fibers in an amount from about 5% to about 95% by weight, based on the total weight of the batt 16. The mineral fibers preferably have a diameter of from about 3 microns to about 30 microns and a length of from about 1 inch to about 2 feet. The organic fibers preferably have a diameter of from about 5 microns to about 20 microns and a length of from about 1 inch to about several feet (only broken as tension increases during formation of the lofted batt 16.)

After creation, but prior to use in forming a base portion 30 of the liner 10 or the like, this lofted batt 16 is usually heated in an oven (not shown), if necessary to keep it pliable. While in a pliable or soft state, the batt 16 is then compacted into a thinner, but still somewhat lofted (semi-compacted) sheet or substrate 18. This moderate compaction may be accomplished by passing the batt 16 between a pair of opposing, spaced-apart endless conveyor belts (not shown). In one embodiment, this initial semi-compaction step creates a sheet or substrate 18 having a substantially constant thickness Tc of between about 10 and about 35 millimeters, see FIG. 2A, and a density of from about 500 grams/m² to about 3500 grams/m². This resulting semi-compacted sheet of material 18 may then be stored for later use, or forwarded for further immediate in-line processing, as outlined in the description that follows.

In accordance with a first embodiment of the present invention, a base portion 30 of a liner 10 having selected desired acoustic properties is created by compressing one or more first regions R₁ of the semi-compacted sheet 18 to a first degree of compaction or thickness, which is referred to herein as the first thickness T₁, one or more second regions R₂ of the sheet 18 to a second degree of compaction or thickness, which is referred to herein as the “second” thickness T₂, one or more third regions R₃ of the sheet 18 to a third degree of compaction or thickness, which is referred to herein as the “third” thickness T₃, and one or more fourth regions R₄ of the sheet 18 to a fourth degree of compaction or thickness, which is referred to herein as the “fourth” thickness T₄. As shown in FIGS. 2A and 2B, this compaction may be easily accomplished by employing a conventional molding process. In the case where the sheet or substrate 18 is allowed to cool after being semi-compacted, it is first necessary to heat the semi-compacted sheet 18 to a temperature of from about 300 degrees F. to about 400 degrees F. to make it soft, pliable and otherwise capable of being molded, i.e., deformed. This can be done by passing the sheet 18 through a warming device, such as an infrared or convection oven (not shown). The heated sheet 18 is then placed between cold opposing dies 20a, 20b in a molding press 20. These dies 20a, 20b are capable of moving relative to each other between open (FIG. 2A) and closed (FIG. 2B) positions (see action arrows A and B).

In the illustrated embodiment, the dies 20a, 20b each have corresponding surface contours, and each is coupled to the press 20, which may comprise a conventional hydraulic or pneumatic press or a like motive device capable of moving the dies towards and away from one another. When brought together, the stationary sheet or substrate 18 is thus compressed or compacted in certain regions or areas, yet remains in a substantially lofted state in others even when opposing halves of the press 20 carrying the dies 20a, 20b are closed. For example, as shown in FIGS. 3A and 3B, the lofted first regions R₁ of the base portion 30 of the liner 10 may remain uncompressed or only slightly compressed at a thickness of between about 3 mm to about 30 mm and preferably at about 25 mm, the lofted second regions R₂ of the base portion 30 may be compressed at a thickness of between about 5 mm to about 20 mm and preferably at about 15 mm, the third regions R₃ of the base portion 30 may be compressed/compacted to a thickness of between about 1 mm to about 10 mm and preferably about 5 mm, and the fourth regions R₄ of the base portion 30 may be compressed/compacted to a thickness of between about 1 mm to about 5 mm and preferably about 3 mm. The third and fourth regions R₃ and R₄ provide the base portion 30 with structural enhancement, as regions or areas compressed to a greater extent are generally more rigid than moderately compressed or lofted areas. As should be appreciated, the degree of compaction/thickness of the substrate 18 during molding is essentially controlled by varying the contours of the dies, and the degree of compression created by the dies 20a, 20b.

By strategically choosing the locations of the lofted and compressed/compacted areas or regions, the sound absorbing or reflecting capabilities of different regions of the base portion 30 of the liner 10 may be selectively controlled. For example, in the case of a headliner H₁, illustrated in FIG. 3C, by positioning the lofted regions (see regions R₁-R₂ in FIGS. 3A-3C) over the areas where the drivers and passengers are seated acoustic energy, such as from tire, engine and/or wind noise is dissipated or attenuated. This is because as thickness increases, while fiber diameter is kept constant, sound absorption increases, and as compaction increases, while fiber diameter is kept constant, sound absorption decreases. A first compacted region R_{3A} also functions somewhat to attenuate sound, such as acoustic energy generated by adjacent structural pillars in the vehicle. Instead of readily absorbing sound energy, the surrounding compacted regions R₄ are designed to assist in provided strength to the liner 10 as well as to reflect sound energy. For example, sound waves conversation (represented by arrows A in FIG. 3A) from the driver or a passenger in a front portion of the vehicle compartment are reflected by an angled front compacted region R_{4F} (the front compacted region R_{4F} is formed at a slight angle to horizontal) towards the passengers in the rear of the vehicle, while other desired sound (represented by arrows B in FIG. 3A), such as from a stereo speaker, is reflected by a rear compacted region R_{4B} towards a passenger sitting in the rear of the vehicle. It is also contemplated that other compacted regions R₃ and R₄ can be shaped so as to reflect desired acoustic energy towards a passenger while still other compacted regions R₃ and R₄ can be shaped so that unwanted sounds such as engine, tire and/or wind noise are reflected away from the passengers. Again, by strategically positioning the lofted and compressed areas or regions, and varying the shape, surface and angular orientation of certain compressed regions, the liner 10 may be adjusted or tuned to enhance the overall acoustic environment by selectively absorbing or reflecting sound energy emanating from different locations (whether inside or outside of the passenger compartment).

At locations where structures are to be mounted, such as handles, lights, consoles, or HVAC ducts, the headliner H may be compressed during molding so as to provide required strength and space for such structures. For example, a recessed space S, see FIG. 3A, is provided in base portion 30 for receiving an HVAC duct which can be mounted directly to the frame of a vehicle, such that it is covered by the base portion 30.

A vehicle roof V_{R} to which the liner base portion 30 is coupled is illustrated in dotted line in FIG. 3A.

As shown in the exploded view of FIG. 3C, the headliner H₁ may comprise a base portion 30 and a fabric layer 22 or the like secured either directly or via a foam layer 24, discussed below, to the exterior surface of the base portion 30. This fabric layer 22 may be formed of a variety of known types of non-woven materials, including those made from polymers, such as polyester, nylon, or polypropylene, or possibly even needled felt or the like. Example fabric layers 22 include a polyester needled felt, one of which is commercially available from Freundenberg Inc. or Foss Mfg. under the product designation “headliner fabric,” and a polyester or nylon tricot fabric layer, examples of which are commercially available from Guilford Co. under the product designations “3 mm Tricot PET” and “3 mm Tricot Nylon.” The tricot fabric layers comprise either a polyester or nylon knit layer coupled to a 3-5 mm open cell polyurethane foam layer. Other tricot fabric layers comprising a polyester layer coupled to a open cell polyurethane foam layer are commercially available from Jhane Barnes Textiles Inc., under the product designation “Pacer Fabric”; from Glen Raven Inc., under the product designation “Aspen Fabric”; from Ebyl Cartex Inc., under the product designation “Providence”; and from Roekona GmbH under the trade designation “Micropile.” The layer 22 provides the headliner HI with an aesthetically pleasing appearance when viewed from the interior of the passenger compartment. The fabric layer 22 may also be provided with a flame-retardant coating or laminated to a flame-retardant material.

In some cases, an optional layer of open cellular polyurethane foam 24, commercially available from Foamex International under the trade designation “headliner foam (open-cell urethane),” may also be placed between the fabric layer 22 and the corresponding surface of the base portion 30. This foam layer 24 serves to further enhance the acoustic properties of the passenger compartment, but may be much thinner, e.g., 3-5 mm, than previously required, since the base portion 30 is capable of absorbing or attenuating the majority of the undesired sound energy. In the case where a foam layer 24 is present, it may be attached to the fabric layer 22 via a conventional flame lamination process. It is noted that a polyester needled felt layer 22 may be used without a foam layer. However, it is preferred that a nylon tricot knit fabric layer be used in combination with a foam layer 24.

The fabric layer 22 or the foam layer 24 may be adhered in place on the liner base portion 30 using a thermoplastic adhesive film, such as a linear low-density polyethylene with an acrylic acid modified copolymer, one of which is commercially available from Dow Automotive Corp. under the product designation “Integral 909,” or using a three or five layer thermoplastic barrier film, such as an adhesive/polypropylene/adhesive, one of which is commercially available from Dow Automotive Corp. under the product designation “Integral 933.” Preferably, the thermoplastic adhesive film is perforated so as to enhance the acoustical performance of the headliner H₁. A web adhesive may also be used to couple the fabric layer 22 or foam layer 24 to the liner base portion 30, one of which is commercially available from Bostik Inc. under the product designation “PE65.” It is further contemplated that a perforated adhesive film commercially available from Sama Xiro GmbH under the product designations “XAF45.001”; “XAF45.201”; “XAF45.301,” may also be used to couple the fabric layer 22 or foam layer 24 to the liner base portion 30.

In accordance with another manner of forming a selectively adjustable or tunable liner, the material forming the liner base portion may be comprised of different areas or regions having fibers of different diameters. If fiber diameter is increased while fiber density and liner thickness are kept constant, fiber surface area decreases and sound absorption decreases. If fiber diameter is decreased while fiber density and liner thickness are kept constant, fiber surface area increases and sound absorption increases. It is contemplated that the diameter of either the mineral fibers, the glass fibers or both the mineral and glass fibers may be varied.

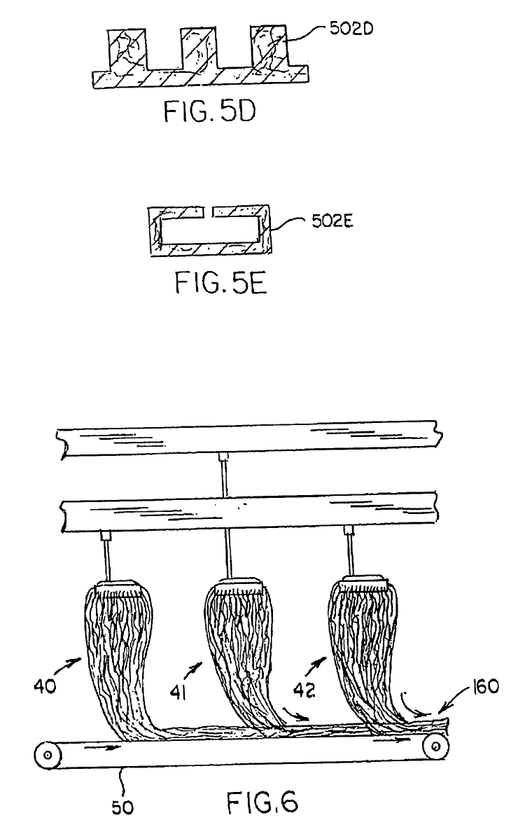

The process for producing such a material involves providing a plurality of sets of different spinners capable of producing different diameter mineral and polymeric fibers. For example, first, second and third separate sets 40-42 of centrifugal spinners 12, 14, see FIG. 6, may be provided for forming co-fiberized fibers of varying diameters. The spinners 12 and 14 in each set 40-42 are preferably constructed as described in U.S. Nos. 5,523,031 and 5,523,032, already incorporated herein by reference, or as described in the other co-fiberizing patents noted above and also incorporated herein by reference. The first, second and third sets 40-42 of centrifugal spinners 12, 14 are positioned adjacent to and in-line with one another in a process direction, i.e., the direction in which the resulting co-fiberized material is conveyed via conveyor 50.

The first set 40 of spinners 12, 14 generate polymeric and glass fibers having a diameter of from about 3 microns to about 10 microns, i.e., fibers having a small diameter, the second set 41 of spinners 12, 14 generate polymeric and glass fibers having a diameter of from about 9 microns to about 15 microns, i.e., fibers having a medium diameter; and the third set 42 of spinners 12, 14 generate polymeric and glass fibers having a diameter of from about 13 microns to about 50 microns, i.e., fibers having a large diameter. The first and second sets 40 and 41 of spinners 12, 14 are positioned relative to the conveyor 50 or appropriate deflecting apparatus is provided such that the small and medium diameter fibers are directed onto a central portion of the conveyor 50. The fibers from the third set 42 of spinners 12, 14 are directed via appropriate structure (not shown) to outer edges of the conveyor 50. It is also contemplated that a fourth set of spinners (not shown) may be provided for forming large diameter fibers such that the third and fourth sets of spinners are positioned along the outer edges of the conveyor 50 for generating large diameter fibers directed to the conveyor outer edges.

The resulting lofted batt 160 of composite fibrous (mineral/organic fiber) material may have a thickness of from about 5 inches to about 3 feet. Any of the materials set out above used in the co-fiberizing process to form batt 16 may be used as well in forming batt 160. After formation, the batt 160 is heated in an oven, if necessary, to keep it pliable, and thereafter compacted, such as by opposing conveyor belts, into a thinner, but still somewhat lofted sheet. At this juncture, the batt 160 has a thickness of from about 10 mm to about 35 mm. The batt 160 is then separated into discrete lengths or substrates (not shown). Each substrate may then be compressed/compacted in a molding process to form a base portion 300 of a headliner, see FIGS. 6A and 6B, having a thickness of from about 5 mm to about 25 mm.

A center section 302 of the base portion 300 comprises the small and medium diameter fibers, while the outer sections 304 and 306 comprise the large diameter fibers, see FIGS. 6A and 6B. The center section 302 is preferably of a sufficient width so as to extend over the driver and passengers sitting in the passenger compartment of the vehicle. Because section 302 comprises small and medium diameter fibers, it functions to dissipate or attenuate undesirable acoustic energy such as engine, tire and/or wind noise. The center section 302 may comprise glass fibers in an amount from about 10% to about 90% by weight, based on the total weight of the center section 302, and polymeric fibers in an amount from about 10% to about 90% by weight, based on the total weight of the center section 302. Further, the center section 302 may have a density of from about 500 grams/m² to about 2000 grams/m².

The large diameter fibers provided in the outer sections 304 and 306 function to provide necessary strength to the base portion 300. Each outer section 304, 306 may comprise glass fibers in an amount from about 10% to about 90% by weight, based on the total weight of the section 304, 306, and polymeric fibers in an amount from about 10% to about 90% by weight, based on the total weight of the section 304, 306. Further, each section 304, 306 may have a density of from about 700 grams/m² to about 3000 grams/m².

It is also contemplated that the fiber density of the outer sections 304 and 306 may be greater than the fiber density of the center section 302. Increased fiber density improves the strength as well as energy absorption capabilities of the sections 304 and 306. It is also contemplated that the thickness of the base portion 300 may be generally constant throughout its length and width, regardless of density, with the thickness falling within a range of from about 3 mm to about 25 mm. A headliner formed from base portion 300 may include one or both of layers 22 and 24 illustrated in FIG. 3C.

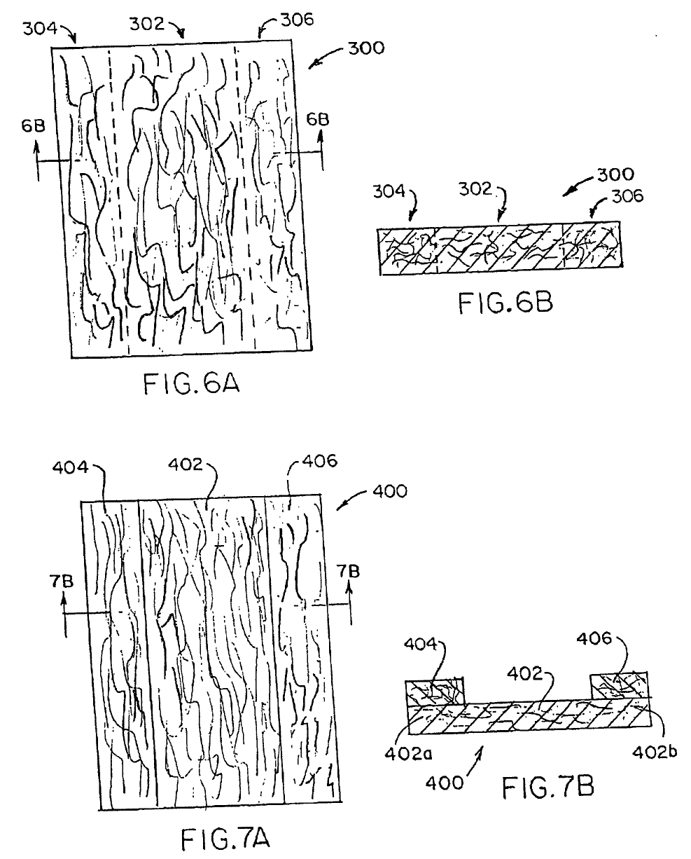

In an alternative embodiment illustrated in FIGS. 7A and 7B, a liner base portion 400 is formed comprising a first layer 402 of co-fiberized polymeric and mineral fibers and second and third outer layers 404 and 406 of co-fiberized polymeric and mineral fibers secured to outer edges 402a and 402b of the first layer. The first layer 402 may comprise polymeric and glass fibers having small to medium diameters ranging from about 4 microns to about 15 microns, while the outer layers 404 and 406 may comprise polymeric and glass fibers having large diameter fibers ranging from about 13 microns to about 30 microns. The fibers of the first layer 402 function to dissipate or attenuate undesirable acoustic energy such as engine, tire and/or wind noise. The large diameter fibers provided in the outer layers 404 and 406 function to provide necessary strength to the base portion 400. The second and third layers 404 and 406 are preferably bonded to the first layer 402 via heat and slight pressure.

The first layer 402 preferably comprise glass fibers in an amount from about 10% to about 90% by weight, based on the total weight of the first layer 402, and polymeric fibers in an amount from about 10% to about 90% by weight, based on the total weight of the first layer 402. Further, the first layer 402 may have a density of from about 300 grams/m² to about 2000 grams/m² and a thickness of from about 3 mm to about 25 mm. Each of the second and third layers 404 and 406 preferably comprises glass fibers in an amount from about 10% to about 90% by weight, based on the total weight of the layer 404, 406, and polymeric fibers in an amount from about 10% to about 90% by weight, based on the total weight of the layer 404, 406. Further, each layer 404, 406 may have a density of from about 700 grams/m² to about 3000 grams/m² and a thickness of from about 1 mm to about 15 mm. A headliner formed from base portion 400 may include one or both of layers 22 and 24 illustrated in FIG. 3C.

Hence, in the case of a headliner, the areas or regions where the absorption or attenuation of sound energy is desired (e.g., those overlying the passenger seats) can be formed by providing the mineral fibers and/or the polymeric fibers in the liner base portion with a smaller diameter (e.g., on the order of from about 4 microns to about 25 microns and preferably about 7 microns to about 11 microns), as compared to fibers in other areas or regions of the sheet forming the liner base portion (e.g., those near the outer edges of the liner), having a larger diameter (between about 11 microns and about 30 microns), so as to absorb less acoustic energy but provide enhanced strength to the base portion. Thus, by strategically forming the liner base portion having different areas or regions with fibers of different diameters, the resulting liner is capable of being tuned to absorb differing amounts of sound energy as necessary to create an optimum acoustical environment. As should be appreciated, the variation in diameters may be from front-to-rear or from side-to-side.

In addition to varying the diameters of the organic and mineral fibers forming the material, it should be appreciated that it also possible to vary the relative degree of compaction, as described above. Thus, in addition to forming certain areas that may have mineral and/or organic fibers having different diameters (e.g., a first area or region may have large diameter fibers while a second area or region may have small to medium diameter fibers), it is also possible to compact these areas in varying amounts to enhance the degree to which ambient sound energy is absorbed and reflected. Thus, by mixing different diameters of mineral and/or organic fibers and selectively compressing certain areas of the liner base portion, the degree of sound reflection or absorption may be carefully and selectively tuned or adjusted to further enhance the acoustics of the passenger compartment.

It is also noted that if fiber density is increased while fiber diameter and liner thickness are kept constant, sound absorption increases. If fiber density is decreased while fiber diameter and liner thickness are kept constant, sound absorption decreases. Hence, by varying fiber density in different regions of the liner base portion, varying the diameter of the mineral and/or organic fibers in different regions of the liner base portion, and/or selectively compressing certain areas of the liner base portion, the degree of sound reflection and absorption may be carefully and selectively tuned or adjusted to further enhance the acoustics of the passenger compartment.

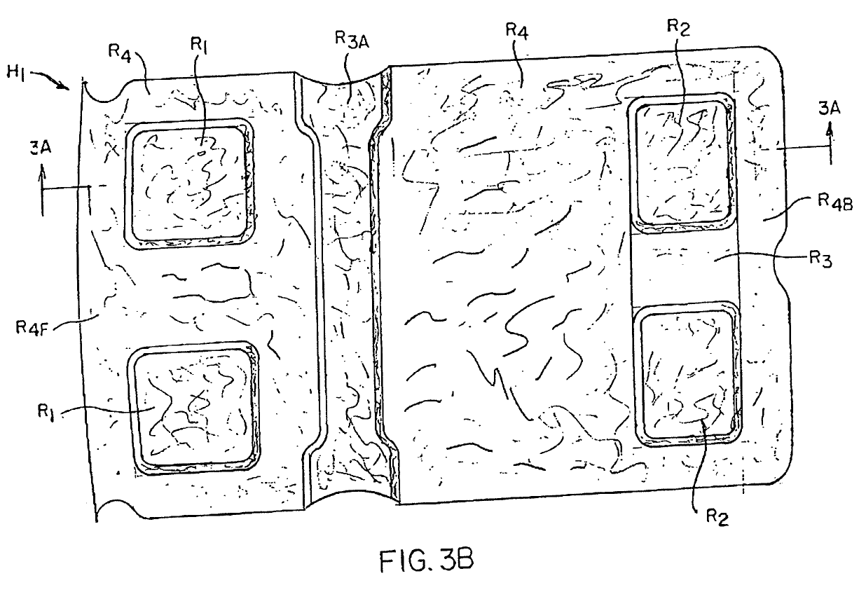

Yet another aspect of the invention is to create a region in all or some of the perimeter of the liner base portion that is capable of absorbing at least a portion of the impact energy of an object, such as the head of a passenger in a vehicle, during a collision. As shown in FIG. 4, where like reference numerals indicate like elements, this energy-absorbing portion is preferably integrally formed in the liner base portion 500 and is comprised of lofted regions R_{P} of the composite material created through the co-fiberizing and cold molding process described above. The lofted regions R_{P} preferably have a thickness of from about 3 mm to about 45 mm, and a density of from 500 grams/m² to about 3000 grams/m². Remaining regions R₁, R₂, R₃, R⁴ are formed of the same material, and have the same thicknesses as the corresponding regions in base portion 30 illustrated in FIGS. 3A and 3C.

It is also contemplated that the lofted regions R_{P} may be made from fibers having a different fiber diameter than those used in the remaining regions R₁, R₂, R₃, R₄ of the base portion 504, as discussed above with regard to the FIG. 6B embodiment. For example, fibers having a larger diameter may be used in the lofted regions R_{P} while fibers having smaller diameters may be used in the remaining regions R₁, R₂, R₃, R₄ of the base portion 504. As noted above, larger fibers contribute to increased strength and therefore better energy absorption.

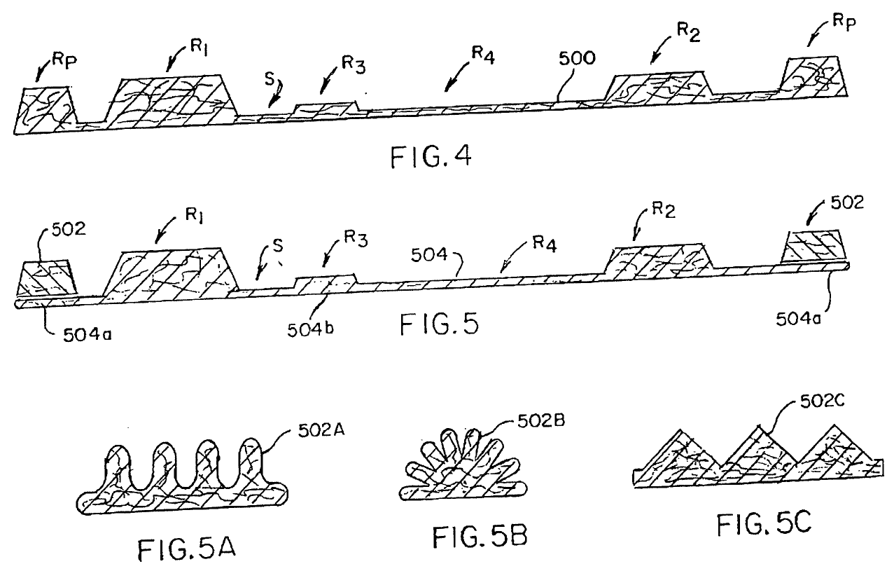

Alternatively, and as shown in the cross-sectional view of FIG. 5, one or more separate components 502 may be attached to the liner base portion 504 (i.e., an edge 504a of a main body 504b of the base portion 504) using an adhesive, such as a hot-melt adhesive, one of which is commercially available from Hot Melt Technologies Inc. under the trade designation “Benchmark 282,” or a pressure sensitive adhesive, one of which is commercially available from Hot Melt Technologies Inc. under the trade designation “Benchmark 6420,” and another of which is commercially available from Fasson Inc. under the product designation “Fasson 2727.” The components 502 and the base portion 504 are formed from the same material from which base portions 30 and 500, discussed above, are formed. Regions R₁, R₂, R₃, R₄ have the same thicknesses as the corresponding regions in base portion 30 illustrated in FIGS. 3A and 3C. The components 502 preferably have a thickness of from about 5 mm to about 50 mm, a density of from about 500 grams/m² to about 3000 grams/m², and may extend part way or completely around the entire outer perimeter of the base portion 504. They function to absorb at least a portion of the impact energy of an object, such as the head of a passenger in a vehicle, during a collision. It is preferable to form the liner base portion from a homogeneous composite material, since this eliminates the need for separation of any impact-absorbing members prior to recycling. However, it is possible to use other types of materials to form the impact-absorbing region in the case where a separate, non-unitary arrangement is provided.

First, second, third, fourth and fifth alternative components 502a-502e, illustrated in cross-section in FIGS. 5A-5E, may be substituted for the component 502, shown in cross-section in FIG. 5. Components having any other geometric shapes may be used as well.

It is also contemplated that the components 502 and 502a-502e may be made from fibers having a different fiber diameter than those used in the base portion 504, as discussed above with regard to the FIG. 7B embodiment. For example, fibers having a larger diameter may be used in the components 502 and 502a-502e while fibers having smaller diameters may be used in the base portion 504. As noted above, larger fibers contribute to increased strength and therefore better energy absorption.

Obvious modifications are also possible in light of the teachings provided above. For instance, it is possible to vary the thickness of the lofted or compressed/compacted areas of the liner base portion for use in other areas, such as in the door panels, package trays, knee bolsters, seat backs, and trunk or floor panels. As with the embodiment described above, the ability to variably compact the material forming the sheet 18, or to easily change its composition, allows for a liner base portion to be specially tuned during fabrication that will have the desired properties to create the desired acoustical environment.

The foregoing description of the present invention has been presented for purposes of illustration and description. It is not intended to be exhaustive or to limit the invention to the precise form disclosed. Obvious modifications or variations are possible in light of the above teachings. The embodiments described were chosen to provide a general illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. An acoustically enhanced liner for selectively insulating a portion of a vehicle from ambient sound energy, comprising:
a base portion fabricated of a composite material comprised of a plurality of mineral fibers and a plurality of organic fibers, said base portion having at least one lofted region for substantially absorbing a portion of the ambient sound energy and at least one compacted region.

2. The liner according to claim 1, wherein the mineral fibers are glass fibers and the organic fibers are formed from a material selected from the group consisting of polypropylene, polyphenylene sulfide, and polyethylene terephthalate.

3. The liner according to claim 1, wherein the base portion is contoured for use as a headliner in a passenger compartment in a vehicle.

4. The liner according to claim 3, wherein the base portion further includes an integral lofted perimeter region that is capable of absorbing a portion of impact energy created during a collision.

5. The liner according to claim 3, further comprising a separate component coupled to at least a portion of a perimeter region of the base portion that is capable of absorbing a portion of impact energy created during a collision.

6. The liner according to claim 5, wherein the separate component is attached to the base portion using an adhesive.

7. The liner according to claim 6, wherein the separate component is fabricated of a composite material comprised of a mixture of mineral fibers and organic fibers.

8. The liner according to claim 1, wherein the base portion is contoured for use as a headliner in a passenger compartment in a vehicle and said at least one lofted region is positioned overlying a driver's seat when installed in the vehicle.

9. The liner according to claim 1, further comprising a fabric layer secured to said base portion.

10. The liner according to claim 9, further comprising a foam layer positioned between said base portion and said fabric layer.

11. The liner according to claim 1, further including at least one angled region, whereby ambient sound energy is reflected from the angled region in a particular direction.

12. The liner according to claim 1, wherein said composite material comprises a co-fiberized composite material.

13. An acoustically enhanced liner for selectively insulating a portion of a vehicle from ambient sound energy, comprising:
a base portion fabricated of a composite material comprised of a plurality of mineral fibers and a plurality of organic fibers, said base portion having at least one first region comprising mineral and organic fibers, at least a portion of the mineral and organic fibers having a first diameter for absorbing a portion of ambient sound energy and at least one second region comprising mineral and organic fibers, at least a portion of the mineral and organic fibers in the second region having a second diameter which is greater than the first diameter.

14. The liner according to claim 13, wherein the base portion further includes a third region having mineral and organic fibers, at least a portion of the fibers in the third region being of a third diameter.

15. A method of manufacturing a liner comprised of a base portion of a composite material including mineral fibers and organic fibers for use in a vehicle, comprising:
providing mineral and organic fibers in a first selected region of the base portion, wherein at least a portion of the fibers in the first region have a first diameter;
providing mineral and organic fibers in a second region of the base portion, wherein at least a portion of the fibers in the second region have a second diameter which is different from the first diameter;
wherein the locations of the fibers having the first and second diameters are selected to provide a desired degree of acoustical enhancement to the base portion.

16. The method according to claim 15, wherein the first diameter of the mineral and organic fibers in the first region is selected so as to result in the first region absorbing a significant portion of ambient sound energy.

17. The method according to claim 15, wherein the second diameter is greater than the first diameter.

18. The method according to claim 17, wherein the first and second regions are provided in a single layer.

19. The method according to claim 17, wherein the first region is provided in a first layer and the second region is provided in a separate, second layer.

20. The method according to claim 15, wherein the substrate is contoured during manufacturing for use as a headliner in the passenger compartment of an automobile, and further including the step of attaching a separate component to the perimeter of the base portion to absorb at least a portion of impact energy during a collision.

21. A method of manufacturing a liner for use in a vehicle, comprising:
providing a composite material substrate including a mixture of mineral fibers and organic fibers; and
forming the composite material substrate into a base portion having one or more compacted first regions and one or more lofted second regions, said lofted regions absorbing a greater amount of sound energy than said compacted regions.

22. The method according to claim 21, wherein the forming step includes placing the substrate between a pair of opposing dies that together form a contour corresponding to the desired shape of the liner.

23. The method according to claim 21, wherein the forming step includes compressing the first region to a first thickness and the second region to a second thickness, wherein the first thickness is less than said second thickness and said first region serves to structurally enhance said liner.

24. The method according to claim 21, wherein the liner is a headliner for use in the passenger compartment of an automobile, and the forming step includes forming said regions such that a lofted region is created in a portion of the liner that will overly the driver's seat in the vehicle.

25. The method according to claim 21, wherein the liner is a headliner for use in the passenger compartment of an automobile, and the forming step includes forming at least one of said regions such that a taper is created in a region of the base portion.

26. The method according to claim 21, wherein the base portion is contoured during manufacturing for use as a headliner in the passenger compartment of an automobile, and further including the step of attaching a separate component to the perimeter of the base portion to absorb at least a portion of impact energy during a collision.

27. A headliner comprising:
a base portion fabricated of a composite material comprised of a plurality of mineral fibers and a plurality of organic fibers, said base portion including a lofted perimeter region that is capable of absorbing a portion of impact energy created during a collision.

28. The headliner according to claim 27, where said lofted perimeter region is defined by a separate component coupled to an edge of a main body of the base portion.

29. The headliner according to claim 27, wherein the separate component is attached to the base portion main body using an adhesive.

30. The headliner according to claim 27, wherein the lofted perimeter region is integral with an edge of a main body of the base portion.
